(19) United States
(12) Patent Application Publication
(10) Pub. No.: US 2010/0174930 A1
(43) Pub. Date: Jul. 8, 2010

(54) Mobile device having organic light emitting display and related display method for power saving

(75) Inventors: Bo Ram Kim, Suwon-si (KR); Won Mi Yoo, Anyang-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/655,642

(22) Filed: Jan. 5, 2010

(30) Foreign Application Priority Data
Jan. 5, 2009 (KR) 10-2009-0000288

(51) Int. Cl. G06F 1/32

(52) U.S. Cl. 713/320

(57) ABSTRACT

After receiving a web page containing several templates from a web server, a mobile device converts an original color in a selected template of the web page into a new color. Then the mobile device displays the color-converted web page on a display unit which may be formed of OLED. Colors of a background template and a text template can be converted into a low brightness color such as black and a high brightness color such as white, respectively. Therefore, when such a web page is displayed on a mobile device, power consumption is effectively reduced. In another embodiment, the web server may perform a color conversion before sending web pages to the mobile device.

### CROSS-REFERENCE TO RELATED APPLICATION(S) AND CLAIM OF PRIORITY

The present application is related to and claims priority to an application entitled “MOBILE DEVICE HAVING ORGANIC LIGHT EMITTING DISPLAY AND RELATED DISPLAY METHOD FOR POWER SAVING” filed in the Korean Intellectual Property Office on Jan. 5, 2009 and assigned Serial No. 10-2009-0000288, the contents of which are incorporated herein by reference.

### TECHNICAL FIELD OF THE INVENTION

The present invention relates, in general, to display technology for a mobile device. More particularly, the present invention relates to a mobile device having an organic light emitting display (OLED) and to a related display method which may allow converting colors of background and text in a web page so as to reduce power consumption in display.

### BACKGROUND OF THE INVENTION

Flat panel displays can be a liquid crystal display (LCD), a field emission display, a plasma display panel (PDP), an organic light emitting display (OLED), and the like.

Among them, the OLED is typically realized by means of an organic light emitting diode in which a light is generated by a combination of electrons and holes in an organic layer formed of a fluorescent or phosphorescent material when a voltage is applied thereto. The organic light emitting diode may be classified into a passive matrix organic light emitting diode (PMOLED) and an active matrix organic light emitting diode (AMOLED). While PMOLED pixels are driven together in lines of pixels to emit light at a time, AMOLED pixels are individually driven. In particular, since having many advantages, such as excellent color reproduction, a faster response time, a wider viewing angle, and a higher contrast ratio, the AMOLED is an emerging display technology for use in a variety of mobile devices such as mobile phones.

In the AMOLED, the amount of power the display consumes varies significantly depending upon the color and brightness shown. That is, displaying a bright color consumes much more power than displaying a dark color does. Considering that power consumption is important to battery life in the mobile device, the AMOLED may be unfavorable for displaying web pages normally based on a white background.

### SUMMARY OF THE INVENTION

To address the above-discussed deficiencies of the prior art, it is a primary object to provide a display technique in a mobile device, which allows converting colors of background and text in a web page so as to reduce power consumption in display.

According to one aspect of the present invention, a display method is provided for a mobile device. The method includes: receiving a web page containing a plurality of templates; converting color information in at least one template selected among the plurality of templates into new color information; and displaying the web page containing the selected template with the new color information.

According to another aspect of the present invention, a display method is provided for a system composed of a web server and a mobile device. The method includes: at the mobile device, sending a connection request signal to the web server, the connection request signal including state information indicating a power-saving mode of the mobile device; at the web server, storing the state information regarding the mobile device; at the web server, converting color information in at least one template into new color information, the at least one template selected from among a plurality of templates contained in a web page; at the web server, transmitting the web page containing the selected template with the new color information to the mobile device; and at the mobile device, displaying the transmitted web page.

According to yet another aspect of the present invention, a mobile device includes: a communication unit configured to receive a web page containing a plurality of templates; a display unit configured to display the web page; and a control unit configured to convert color information in at least one template selected among the plurality of templates into new color information and control the display unit to display the web page containing the selected template with the new color information.

According to still yet another aspect of the present invention, a system includes: a mobile device configured to send a connection request signal to a web server, receive a web page containing a plurality of templates from the web server, and display the received web page, wherein the connection request signal has state information indicating a power-saving mode of the mobile device; and the web server configured to store the state information about the mobile device, convert color information in at least one template selected among the plurality of templates into new color information, and transmit the web page containing the selected template with the new color information to the mobile device.

Aspects of the present invention can represent a white text on a black background when a web page is displayed on a mobile device, thus effectively reducing power consumption in such a mobile device, especially having the OLED. Furthermore, images contained in a web page may remain in their original colors without conversion, and also, text may be clearly distinguished from background due to increased contrast ratio there between.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a web page displayed on a screen in accordance with an exemplary embodiment of the present invention;

FIG. 2 illustrates a configuration of a mobile device in accordance with an exemplary embodiment of the present invention;

FIG. 3 illustrates a process for displaying a web page transmitted from a web server in accordance with an exemplary embodiment of the present invention;

FIG. 4 illustrates a process for transmitting and receiving a web page in a system composed of a web server and a mobile device in accordance with an exemplary embodiment of the present invention;

FIG. 5 illustrates a process for displaying a web page at a mobile device in accordance with an exemplary embodiment of the present invention; and

FIG. 6 illustrates a process for transmitting a web page at a web server in accordance with an exemplary embodiment of the present invention.

### DETAILED DESCRIPTION OF THE INVENTION

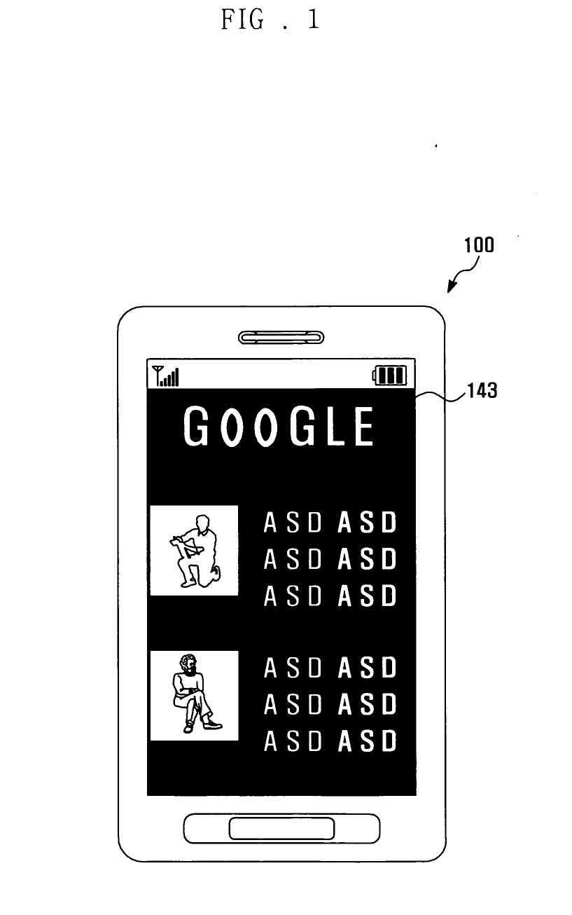

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Among terms set forth herein, a ‘web page’ or webpage refers to a document or resource of information that is suitable for the World Wide Web and can be accessed through a web browser and displayed on a mobile device. The web page is provided from a web server selectively connected with the mobile device through the Internet. The web page is generally composed of a plurality of templates.

Furthermore, a ‘template’ refers to a form of separation of presentation and content in a web page. The template may be categorized into an image template including image related data, a background template including background related data, a text template including text data, and so forth. Each individual template includes color information and position information necessary for displaying data on the mobile device.

FIG. 1 illustrates a web page displayed on a screen in accordance with an exemplary embodiment of the present invention.

Referring to FIG. 1, the mobile device 100 that includes the OLED can display, on a display unit 143, a web page that is transmitted from a web server selected by a user. In particular, the mobile device 100 can display a white text on a black background, for example, as shown in FIG. 1. However, images contained in the web page may be displayed in their original colors. Displaying of text and background after converting their colors may reduce effectively power consumption while such web pages are displayed on the OLED mobile device 100. Additionally, the contrast ratio between text and background is remarkably increased, so text may be clearly distinguished from background when displayed.

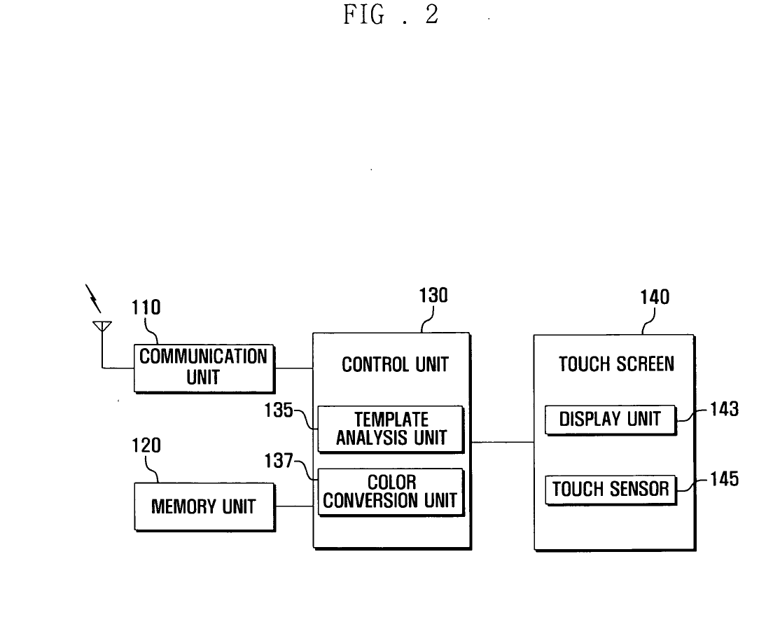

Described hereinafter with reference to FIG. 2 is the mobile device 100 which allows displaying text and background after converting their colors. FIG. 2 illustrates a configuration of a mobile device in accordance with an exemplary embodiment of the present invention.

Referring to FIG. 2, the mobile device 100 includes a communication unit 110, a memory unit 120, a control unit 130, and a touch screen 140.

Specifically, the communication unit 110 is configured to establish a communication channel with a base station for a voice call between mobile devices. Additionally, the communication unit 110 can be connected with web servers through the Internet and then receive web pages from the web servers. The communication unit 110 can include an RF transmitter that upwardly converts the frequency of signals to be transmitted and amplifies the converted signals, and an RF receiver that amplifies received signals with low-noise and downwardly converts their frequency.

Particularly, the communication unit 110 can send a connection request signal to a specific one of web servers and thereby a connection is established under the control of the control unit 130. Furthermore, the communication unit 110 can send a web page request signal to the connected web server and then receive web pages from the web server under the control of the control unit 130. When the mobile device 100 is in a power-saving mode under the control of the control unit 130, the connection request signal can contain state information that indicates whether the mobile device 100 is in the power-saving mode or not.

The memory unit 120 is configured to store a variety of application programs related to functions of the mobile device 100 and data required for or created during the execution of functions. In particular, the memory unit 120 can store web pages received from the web servers under the control of the control unit 130.

The control unit 130 is configured to control the state and operation of elements in the mobile device 100. In particular, the control unit 130 can include a template analysis unit 135 and a color conversion unit 137 so as to convert colors of web pages received from the web servers in an Internet mode.

The template analysis unit 135 analyzes templates contained in each individual web page received from the web server. As discussed above, the template contains a variety of data constituting the web page and includes an image template, a background template, a text template, and so forth. Each individual template includes color information necessary for displaying the web page on the display unit 143. In order to convert colors of text and background, the template analysis unit 135 retrieves color information from at least one of the text template and the background template.

The color conversion unit 137 converts the retrieved color information into new color information. Specifically, the color conversion unit 137 converts original color information in the background template into new color information with relatively low brightness. Additionally, the color conversion unit 137 converts original color information in the text template into new color information with relatively high brightness. For example, if the background template designates white as original color information, the color conversion unit 137 converts white into black as new color information with relatively low brightness. Similarly, if the text template designates black as original color information, the color conversion unit 137 converts black into white as new color information with relatively high brightness. Therefore, the control unit 130 can control the display unit 143 to display the web page having a white text on a black background.

In another embodiment, colors of some templates may be previously converted at the web server itself before the web page is sent to the mobile device 100. In this case, the control unit 130 of the mobile device 100 transmits the connection request signal, which includes state information indicating the power-saving mode of the mobile device 100, to the web server through the communication unit 110. On receipt of the connection request signal, the web server checks templates of the web page to be sent to the mobile device 100 and respectively converts color information in the background template and the text template into black and white. Then the web server transmits the web page that includes a white text on a black background to the mobile device 100. On receipt of the web page through the communication unit 110, the mobile device 100 displays the received web page on the display unit 143.

The touch screen 140 is composed of the display unit 143 and a touch sensor 145. The display unit 143 outputs various scenes or graphical data, on a screen, which are related to the state and operation of the mobile device 100 or produced by the execution of functions in the mobile device 100. The display unit 143 may be formed of the OLED, especially the AMOLED, and can represent various colors under the control of the control unit 130.

Additionally, the display unit 143 can display web pages received from web servers under the control of the control unit 130. In particular, the web page displayed on the display unit 143 can include a white text on a black background. Therefore, text can be clearly distinguished from background, and displaying of background in black can reduce effectively power consumption of the mobile device 100.

The touch sensor 145 is provided near the display unit 143 and detects a touch gesture by a certain input tool, such as a user's finger or a stylus pen. That is, the touch sensor 145 detects the contact or release of the input tool on or from the surface of the touch screen 140. The touch sensor 145 determines the coordinates of the contact and release and then transmits them to the control unit 130.

Although examples of the mobile device 100 described herein include the touch screen 140, this is exemplary only and should not to be considered as a limitation of the present invention. In an alternative embodiment, the mobile device 100 includes a keypad as an input unit and also the OLED display unit 143. Additionally, the mobile device 100 can include other elements, such as a camera module and a digital multimedia broadcasting (DMB) receiver.

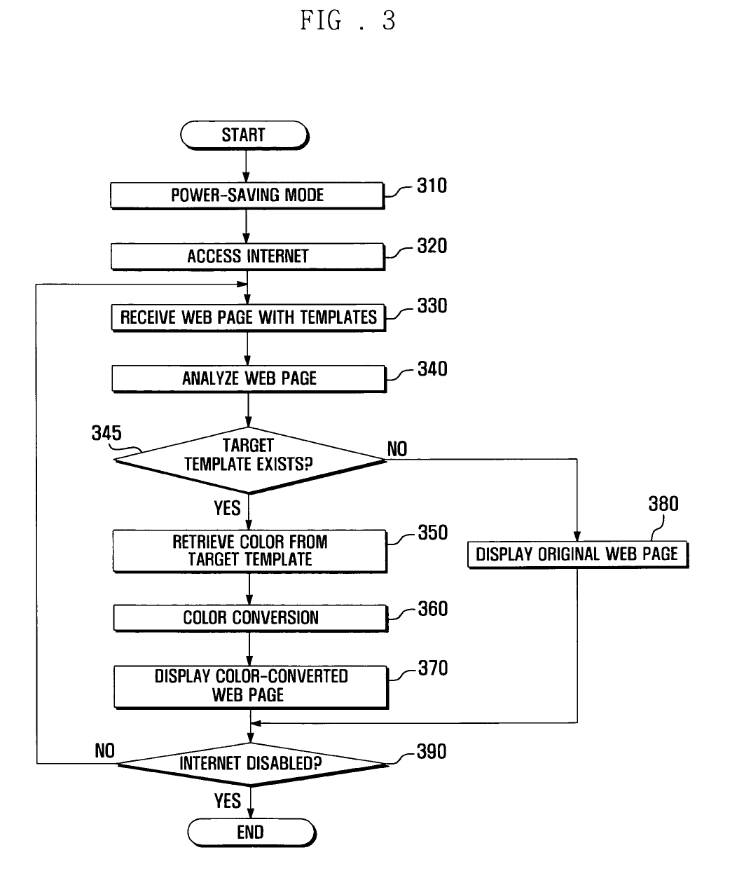

Described hereinabove is the mobile device 100 that allows displaying text and background after converting their colors. Next, a method for displaying a web page will be described with reference to FIG. 3. Hereinafter, the aforesaid elements of the mobile device 100 will be indicated by the same reference numbers as those shown in FIG. 2.

FIG. 3 illustrates a process for displaying a web page transmitted from a web server in accordance with an exemplary embodiment of the present invention.

Referring to FIG. 3, when a user selects a power-saving mode through a suitable menu or function key, the control unit 130 enables the power-saving mode (step 310). Furthermore, when a user selects an Internet mode through a suitable menu or function key, the control unit 130 controls the communication unit 110 to access the Internet network and then to establish a connection with a web server (step 320).

Next, the control unit 130 receives a web page from the web server through the communication unit 110 (step 330). Here, the web page can be formed of at least one template such as a background template, a text template, and an image template. Then, for a color conversion, the control unit 130 analyzes all templates contained in the received web page (step 340) and determines whether there exists a template requiring a color conversion (step 345). Among templates in the web page, the background template and the text template can be considered as the target of a color conversion.

If there is a target template that needs a color conversion, the control unit 130 retrieves color from the target template (step 350). Specifically, the control unit 130 finds colors contained in the text template and the background template and then retrieves the colors. Thereafter, the control unit 130 converts the retrieved color into new color (step 360). Specifically, the control unit 130 converts the original color in the background template into a new color with relatively low brightness, and converts the original color in the text template into a new color with relatively high brightness. For example, if white is the original color in the background template, the control unit 130 converts white into black, which is a new color with relatively low brightness. Similarly, if black is the original color in the text template, the control unit 130 converts black into white, which is a new color with relatively high brightness.

Next, the control unit 130 outputs the web page that includes the color-converted template on the display unit 143 (step 370). Specifically, the control unit 130 controls the display unit 143 to display the web page that includes a white text on a black background. Thereafter, the control unit 130 determines whether an Internet mode is disabled (step 390). If the Internet mode remains enabled, the control unit 130 again performs the aforesaid steps from the step 330. That is, whenever web pages are received from the web server depending upon a user's selection, the control unit 130 performs a color conversion for templates in the received web pages and then displays the web page with a white text on a black background.

Returning to the above step 345, if there is no template that needs a color conversion, the control unit 130 outputs the web page on the display unit 143 as received from the web server (step 380). Specifically, a background template that includes a low brightness color like black, a text template including a high brightness color like white, or other templates such as an image template requiring no color conversion can be displayed in non-converted original color on the display unit 143.

Described hereinabove is a method for displaying web pages in the mobile device 100 through a color conversion for text and background in the web pages. Although the above illustrates the case where a color conversion is made only in a power-saving mode, this is exemplary only and should not to be considered as a limitation of the present invention. In an alternative embodiment, the control unit 130 performs a color conversion for text and background in web pages regardless of enabling or not of a power-saving mode. Additionally, new colors of text and background, converted from their original colors, may not be limited to white and black and may vary according to a user's selection. Original colors of text and background have only to be converted into a low brightness color and a high brightness color, respectively.

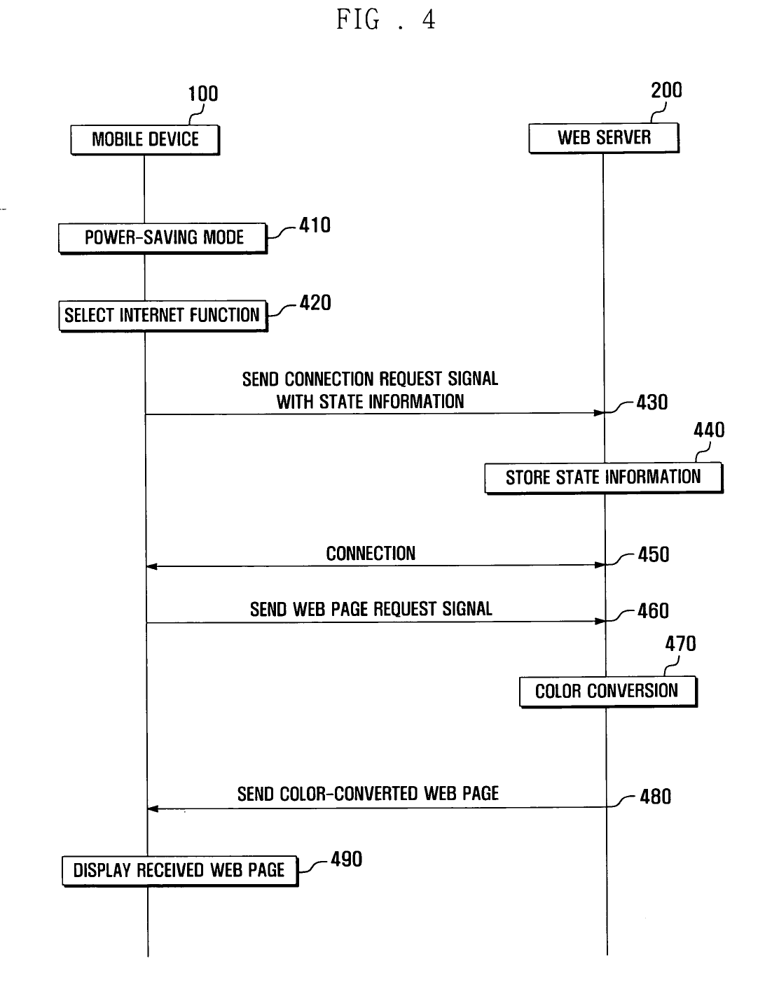

Next, a method for converting colors of web pages at a web server and then sending them to a mobile device will be described with reference to FIGS. 4 to 6.

FIG. 4 illustrates a process for transmitting and receiving a web page in a system composed of a web server and a mobile device in accordance with an exemplary embodiment of the present invention.

Referring to FIG. 4, at the outset, the mobile device 100 enables a power-saving mode according to a user's selection (step 410). When an Internet function is selected by a user (step 420), the mobile device 100 sends a connection request signal containing state information to a web server 200 (step 430). Here, station information indicates whether the mobile device 100 is in the power-saving mode or not.

Upon receipt of the connection request signal from the mobile device 100, the web server 200 stores the state information about the mobile device 100 (step 440). That is, the web server 200 records that the mobile device 100 sending the connection request signal is in the power-saving mode. Then the web server 200 sends a connection response message to the mobile device 100, and therefore a connection is established between the web server 200 and the mobile device 100 (step 450).

Next, the mobile device 100 sends a web page request signal to the web server 200, depending upon a user's selection (step 460). Then the web server 200 retrieves a specific web page in response to the web page request signal and converts colors of the retrieved web page into new colors, depending upon the state information about the mobile device 100 (step 470). Specifically, the web server 200 verifies that the mobile device 100 is in the power-saving mode, and selects templates requiring a color conversion in the web page requested by the mobile device 100. Then the web server 200 retrieves color information from the selected templates, i.e., the background template and the text template, and converts the retrieved color information into new color information. That is, the original color of the background template is converted into a new color with relatively low brightness (e.g., black), and the original color of the text template is converted into a new color with relatively high brightness (e.g., white).

Thereafter, the web server 200 transmits the web page including color-converted templates to the mobile device 100 (step 480). Then, the mobile device 100 displays the received web page (step 490). Here, the displayed web page is composed of background in a low brightness color (e.g., black), text in a high brightness color (e.g., white), and images in the original color.

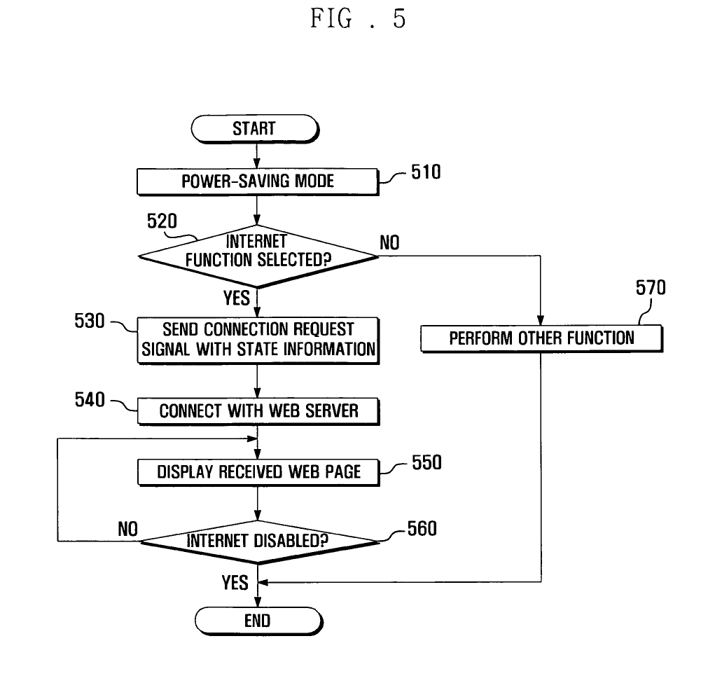

Described below with reference to FIG. 5 illustrates a process for displaying a web page received from a web server at a mobile device. Hereinafter, the aforesaid elements of the mobile device 100 will be indicated by the same reference numbers as those shown in FIG. 2. FIG. 5 illustrates a process for displaying a web page at a mobile device in accordance with an exemplary embodiment of the present invention.

Referring to FIG. 5, the control unit 130 enables a power-saving mode according to a user's selection (step 510). Then the control unit 130 determines whether an Internet function is selected by a user (step 520). Here, the Internet function refers to a function that allows accessing a selected web server (200 in FIG. 4) and receives web pages from the web server 200 through the communication unit 110. The web page contains a variety of data and is composed of templates. Each individual template includes data and related information about images, text and background in the web page, and also, contains color information necessary for displaying a web page.

When the Internet function is selected by a user, the control unit 130 transmits a connection request signal to a selected web server 200 through the communication unit 110 (step 530). Here, the connection request signal contains state information that indicates whether the mobile device 100 is in the power-saving mode or not. Next, when a connection response signal is received from the web server 200, the control unit 130 establishes a connection with the web server 200 through the communication unit 110 (step 540).

Additionally, when a web page is received from the web server 200 through the communication unit 110, the control unit 130 outputs the received web page on the display unit 143 (step 550). Here, the web page received from the web server 200 includes color-converted templates as discussed above in FIG. 4. Therefore, the display unit 143 can display the web page with text in a high brightness color (e.g., white) on background in a low brightness color (e.g., black). Then the control unit 130 determines whether the Internet function is disabled (step 560). If the Internet function remains enabled, the control unit 130 returns to the above step 550 and displays on the display unit 143 a web page received from the web server 200.

Alternatively, if the Internet function is not selected in the aforesaid step 520, the control unit 130 performs other function depending on a user's selection (step 570). Typical functions, such as a voice call, a video call, a message service, and a camera may be selectively performed in this step 570.

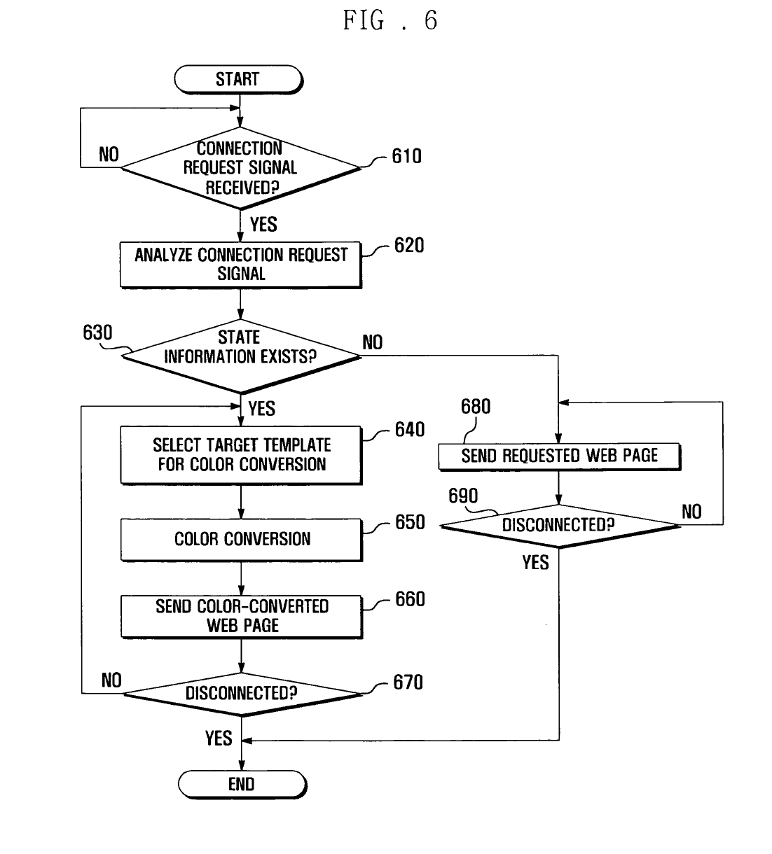

Next, a method for sending a web page from a web server to a mobile device will be described with reference to FIG. 6. FIG. 6 illustrates a process for transmitting a web page at a web server in accordance with an exemplary embodiment of the present invention.

Referring to FIG. 6, the web server 200 determines whether a connection request signal is received from the mobile device 100 (step 610). When the connection request signal is received, the web server 200 analyzes the received signal (step 620). Then the web server 200 determines whether the connection request signal contains state information about the mobile device 100 (step 630). Here, station information indicates whether the mobile device 100 is in the power-saving mode or not.

If there is state information regarding the mobile device 100 in the connection request signal, the web server 200 stores the state information about the mobile device 100. Additionally, upon receipt of a web page request signal from the mobile device 100, the web server 200 selects target templates for a color conversion among all templates contained in the web page to be sent to the mobile device 100 (step 640). Here, the selected target templates include a background template and a text template, except an image template. Thereafter, the web server 200 retrieves color information from the selected templates and then converts the retrieved color information into new color information (step 650).

That is, the original color of the background template is converted into a new color with relatively low brightness (e.g., black), and the original color of the text template is converted into a new color with relatively high brightness (e.g., white). Then, the web server 200 inserts new color information into each individual template. Additionally, such color-converted web pages may be stored in the web server 200.

Thereafter, the web server 200 transmits the web page including color-converted templates to the mobile device 100 (step 660). Then, the web server 200 determines whether a disconnection request signal is received from the mobile device 100 (step 670). If no disconnection request signal is received, the web server 200 returns to the above step 640. Through this repeated sequence, the web server 200 continuously checks templates in every web page to be sent to the mobile device 100 and performs a color conversion for target templates while the mobile device 100 is in the power-saving mode.

Alternatively, if it is determined in the above step 630 that there is no state information about the mobile device 100, the web server 200 sends a web page as requested by the mobile device 100 (step 680). Then, the web server 200 determines whether a disconnection request signal is received from the mobile device 100 (step 690). Until the disconnection request signal is received, the web server 200 repeatedly performs the above step 680.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A display method for a mobile device, the method comprising:
receiving a web page comprising a plurality of templates;
converting color information in at least one template selected among the plurality of templates into new color information; and
displaying the web page comprising the selected template with the new color information.

2. The method of claim 1, wherein the converting of the color information includes selecting a background template among the templates and converting color information in the background template into new color information with relatively low brightness.

3. The method of claim 2, wherein the new color information with relatively low brightness includes black.

4. The method of claim 2, wherein converting of the color information further includes selecting a text template among the templates and converting color information in the text template into new color information with relatively high brightness.

5. The method of claim 4, wherein the new color information with relatively high brightness includes white.

6. The method of claim 1, wherein an image template is not selected in the converting of the color information.

7. A display method for a system, the system comprising a web server capable of communicating with a mobile device, the method comprising:
receiving, by the web server, a connection request signal, the connection request signal including state information indicating a power-saving mode of the mobile device;
storing, by the web server, the state information about the mobile device;
converting color information in at least one template into new color information, the at least one template being selected among a plurality of templates contained in a web page; and
transmitting the web page containing the selected template with the new color information to the mobile device, wherein the transmitted web page is configured to be displayed at the mobile device.

8. The method of claim 7, wherein converting of the color information includes selecting a background template among the templates and converting color information in the background template into new color information with relatively low brightness.

9. The method of claim 8, wherein new color information with relatively low brightness includes black.

10. The method of claim 8, wherein converting of the color information further includes selecting a text template among the templates and converting color information in the text template into new color information with relatively high brightness.

11. The method of claim 10, wherein the new color information with relatively high brightness includes white.

12. The method of claim 7, wherein converting of the color information includes storing the web page containing the selected template with the new color information at the web server.

13. A mobile device comprising:
a communication unit configured to receive a web page comprising a plurality of templates;
a display unit configured to display the web page; and
a control unit configured to convert color information in at least one template selected among the plurality of templates into new color information and control the display unit to display the web page comprising the selected template with the new color information.

14. The device of claim 13, wherein the control unit further is configured to select a background template among the templates.

15. The device of claim 14, wherein the control unit further is configured to convert color information in the background template into new color information with relatively low brightness, the new color information including black.

16. The device of claim 13, wherein the control unit further is configured to select a text template among the templates and convert color information in the text template into new color information with relatively high brightness, the new color information including white.

17. The device of claim 13, wherein the control unit further is configured to exclude an image template from selecting for converting of the color information.

18. A web server configured to receive a connection request signal from a mobile device, the web server configured to transmit a web page comprising a plurality of templates, wherein the connection request signal comprises state information indicating a power-saving mode of the mobile device, and the web server further configured to store the state information about the mobile device, convert color information in at least one template selected among the plurality of templates into new color information, and transmit the web page comprising the selected template with the new color information to the mobile device.

19. The system of claim 18, wherein the web server is further configured to select a background template among the templates and convert color information in the background template into new color information with relatively low brightness, the new color information including black.

20. The system of claim 18, wherein the web server is further configured to select a text template among the templates and convert color information in the text template into new color information with relatively high brightness, the new color information including white.
